(19) United States
(12) Patent Application Publication
(10) Pub. No.: US 2023/0406332 A1
(43) Pub. Date: Dec. 21, 2023

(54) VEHICLE CONTROL SYSTEM

(71) Applicant: Mitsubishi Electric Corporation, Tokyo (JP)

(72) Inventors: Hajime HASEGAWA, Tokyo (JP); Shigeki TSUJII, Tokyo (JP); Daisuke YASE, Tokyo (JP); Osamu MAEDA, Tokyo (JP); Tatsuya MAEKOBA, Tokyo (JP)

(73) Assignee: Mitsubishi Electric Corporation, Tokyo (JP)

(21) Appl. No.: 18/033,506

(22) PCT Filed: Nov. 16, 2020
(86) PCT No.: PCT/JP2020/042571

§ 371 Date: Apr. 24, 2023

(51) Int. Cl. B60W 50/023; B60W 60/00; B60W 50/029; B60W 50/02

(52) U.S. Cl. CPC B60W 50/023; B60W 60/00186; B60W 50/029; B60W 50/0205; B60W 2420/42; B60W 2556/10

(57) ABSTRACT

In the case of an automated driving vehicle capable of autonomous traveling, it has to deal also with failures at two spots. In order to drive actuators at the time of failures of two controllers, it is necessary to additionally provide controllers capable of making real-time calculations and thus, there is a problem that the cost will increase. A vehicle control system according to this application is a vehicle control system which comprises a control device that has two calculation devices for real-time control and two calculation devices for non-real-time control, and that drives a drive unit on the basis of control target values; wherein these calculation devices are configured so that, when one or two of them have failed, another one of these calculation devices takes over functions of the failed calculation device or devices.

### TECHNICAL FIELD

The present application relates to a vehicle control system.

### BACKGROUND ART

With respect to vehicle control systems, each vehicle is provided with multiple sensors and multiple actuators and is controlled in such a state in which they are connected to control devices. For automated driving vehicles without the need of operation for the vehicle by the driver, it is required, when a failure occurs in the control device that performs advanced control, to deal with the failure autonomously with no operation by the driver. As a countermeasure, a system has been proposed in which a backup control device is installed that operates at the time of the failure so that even at the time of the failure, the system can deal therewith by using the backup control device. However, it is thought that, if the number of control devices are so increased, the installation space will be increased, the wiring design will be complicated and the cost of development will be increased. Thus, there is a demand that the system can deal with the failure with a minimum configuration.

The vehicle control system is required as a whole to perform backup processing against an error without needlessly increasing the redundancy of each of the control devices. It is desired to ensure a low cost, a high reliability, a real-time property and a scalability, in a well-balanced manner.

### CITATION LIST

### Patent Literature

Patent Document 1: Japanese Patent No. 6214730

### SUMMARY OF INVENTION

### Technical Problem

In the vehicle control system described in Patent Document 1, an actuator controller drives an actuator in response to an instruction of a command controller that controls the vehicle. Both of the command controller and the actuator controller can make real-time calculations. If the command controller is disabled, the functions of the command controller are instead performed by the actuator controller, so that continuous operation can be kept. However, this system can deal with only a failure of the command controller, and if both of the controllers, namely, the command controller and the actuator controller have failed, it is not possible to give the instruction for driving the actuator. Accordingly, in the case of double failures of these controllers, it is difficult to take measures for autonomous traveling.

In the case of the automated driving vehicle capable of autonomous traveling, it has to deal also with failures at two spots. In order to drive an actuator at the time of failures of two controllers therefor, it is necessary to additionally provide a controller capable of making real-time calculations and thus, there is a problem that the cost will increase.

This application has been made to solve such a problem, and an object thereof is to provide a vehicle control system which makes it possible, for an automated driving vehicle to perform autonomous traveling, to take measures for autonomous traveling even when such two calculation devices for real-time control have failed, without needlessly increasing the redundancy.

### Solution to Problem

A vehicle control system according to this application comprises:
sensors that detect an environment around a vehicle;
actuators that control the vehicle;
a drive unit that drives the actuators; and
a control device that has two calculation devices for real-time control and two calculation devices for non-real-time control, and that calculates control target values for the vehicle on a basis of signals of the sensors to thereby drive the drive unit on a basis of the control target values;
wherein these calculation devices are configured so that, when one or two of these calculation devices have failed, another one of these calculation devices takes over functions of the failed calculation device or devices.

### Advantageous Effects of Invention

The vehicle control system according to this application makes it possible, for an automated driving vehicle to perform autonomous traveling, to take measures for autonomous traveling even when two calculation devices for real-time control have failed, without needlessly increasing the redundancy.

### BRIEF DESCRIPTION OF DRAWINGS

FIG. 1 is a configuration diagram of a vehicle control system according to Embodiment 1.

FIG. 2 is a hardware configuration diagram of a control unit according to Embodiment 1.

FIG. 3 is a first flowchart of calculation for real-time control by a calculation device 205 according to Embodiment 1.

FIG. 4 is a second flowchart of calculation for real-time control by the calculation device 205 according to Embodiment 1.

FIG. 5 is a first flowchart of calculation for real-time control by a calculation device 305 according to Embodiment 1.

FIG. 6 is a second flowchart of calculation for real-time control by the calculation device 305 according to Embodiment 1.

FIG. 7 is a flowchart of calculation for non-real-time control by a calculation device 101 according to Embodiment 1.

FIG. 8 is a flowchart of calculation for non-real-time control by a calculation device 201 according to Embodiment 1.

FIG. 9 is a flowchart of preferential processing in calculation for non-real-time control by the calculation device 101 according to Embodiment 1.

FIG. 10 is a flowchart of preferential processing in calculation for non-real-time control by the calculation device 201 according to Embodiment 1.

FIG. 11 is a flowchart about drive signals outputted by a communication unit 104 according to Embodiment 1.

FIG. 12 is a flowchart about drive signals outputted by a communication unit 204 according to Embodiment 1.

FIG. 13 is a configuration diagram of a vehicle control system according to Embodiment 2.

### DESCRIPTION OF EMBODIMENTS

Hereinafter, vehicle control systems according to embodiments of this application will be described with reference to the drawings.

### 1. Embodiment 1

<Configuration of Vehicle Control System>

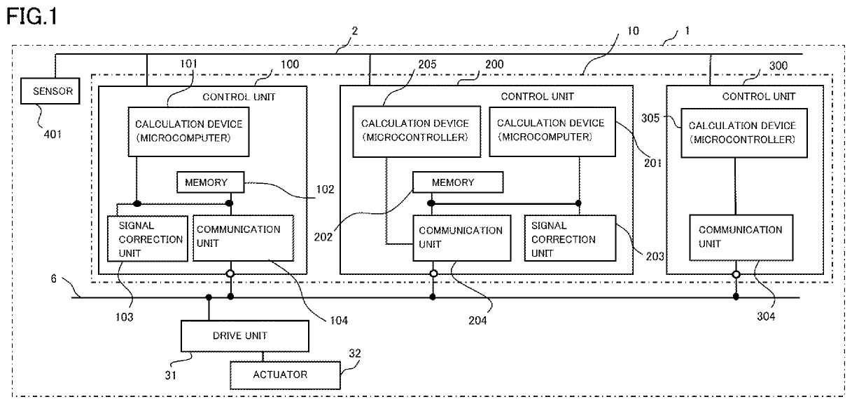

In a vehicle control system 1 shown in FIG. 1, a control device 10 has control units 100, 200, 300, and these three control units each have one or two calculation devices. The functions to be installed in the control units 100, 200, 300 are not fixedly provided according to their mounting positions, but are allocated according to control cycles and processing capacities possessed by the control units.

In order to mutually share outputs of a sensor 401 and calculation results of the control units 100, 200, 300, the control units 100, 200, 300 are connected to each other through a core communication network 2. When, for example, a communication protocol defined in IEEE 802.3, a communication protocol defined in ISO 11898, a communication protocol defined in ISO 17458, or the like, is used in the core communication network 2, it is possible to achieve large-capacity and service-oriented communications. Further, it is possible to achieve the control units 100, 200, 300 with a virtualized allocation of functions. In other words, it is possible to reallocate the functions allocated in the control units 100, 200, 300.

With respect to the connection method of the core communication network 2, when its loop is duplicated, the vehicle control system 1 is prevented from malfunctioning due to a disconnection in the core communication network 2.

The outputs of the sensor 401 are transferred by way of the core communication network 2 to one or all of the control units 100, 200, 300. The control units 100, 200, 300 import the signals of the sensor 401, thereby to update information of an environment around the vehicle and to update a vehicle traveling route up to the destination. Then, they calculate control target values for the vehicle on the basis of the thus-updated vehicle traveling route, and transfer drive signals to a drive unit 31 on the basis of the control target values.

The control units 100, 200, 300 transfer the drive signals through a control communication network 6 to the drive unit 31. The drive unit 31 drives an actuator 32 on the basis of the received drive signals. By the actuator 32, a vehicle security setting/releasing operation, a power transmission operation, a steering operation, a braking operation and the like are performed. The actuator 32 is a general collective term of a variety of actuators and drive circuits thereof. For example, the actuator 32 is configured with actuators and drive circuits, etc. that perform a door locking/unlocking operation; operate a fuel injection valve and a throttle control valve; operate inverters for controlling driving direction, driving force and driving speed of steering by an electric power steering device; operate a brake control motor of an electric brake device; operate a solenoid valve of an air adjusting device; perform a turn on/off operation of a lighting device; perform a raising/lowering operation of a power window; and do something like that.

The actuator 32 is assumed to be components that are required to be controlled at low latency. In the actuator 32, a component that is not required to have redundancy and is allowed to be delayed, for example, a raising/lowering controller of a power window, may instead be driven and controlled in such a manner that it is connected directly to the control units 100, 200, 300, separately from the actuator 32.

The sensor 401 is a general collective term of a variety of sensors. In order to acquire an environment around the vehicle and to detect the position of itself, the sensor 401 is configured with, for example, a camera, a radar, a LiDAR (Laser Imaging Detection and Ranging), a satellite positioning locator, an autonomous locator, etc. The sensor 401 may include, for example, a motor rotation angle sensor, a speed meter, a camera installation angle meter, a radio wave receiver or the like. The signals of the sensor 401 are transferred by way of the core communication network 2 to the control units 100, 200, 300; however, they may also be transferred thereto by way of the control communication network 6 in addition to the core communication network 2. Further, redundancy may be increased by employing such a configuration in which, in addition to the core communication network 2, communication lines are connected directly to the control units 100, 200, 300.

In the control communication network 6, like in the core communication network 2, a communication protocol defined in IEEE 802.3, a communication protocol defined in ISO 11898, a communication protocol defined in ISO 17458, or the like, may be used, for example.

The control unit 100 has a calculation device 101 for non-real-time control that executes calculations. The calculation device 101 executes calculations for non-real-time control on the basis of signals of the sensor 401, to thereby update information of the environment around the vehicle. The control unit 100 has a memory 102 that stores programs of the calculation device 101 and drive signals in a period from a current time until the elapse of a predetermined transition period. As the memory, a non-volatile memory may be used. The control unit 100 has a signal correction unit 103 that, when this control unit is going to take autonomous measures at the time of failure, corrects the drive signals to be transferred from the calculation device 101 to the drive unit 31. Further, the control unit 100 has a communication unit 104 that transmits the drive signals from the control unit 100 to the control communication network 6.

The control unit 200 has a calculation device 201 for non-real-time control and a calculation device 205 for real-time control that each execute calculations. The calculation device 201 executes calculations for non-real-time control on the basis of signals of the sensor 401 and the information of the environment around the vehicle updated in the control unit 100, to thereby update the vehicle traveling route. The control unit 200 has a memory 202 that stores programs of the calculation device 201 and drive signals in a period from a current time until the elapse of a predetermined transition period. As the memory, a non-volatile memory may be used. The control unit 200 has a signal correction unit 203 that, when this control unit is going to take autonomous measures at the time of failure, corrects the drive signals to be transferred from the calculation device 201 to the drive unit 31.

The calculation device 205 executes calculations for real-time control on the basis of signals of the sensor 401, to thereby execute security verification. The calculation device 205 outputs drive signals on the basis of the result of the security verification. The drive signals include an output for locking/unlocking the vehicle and an output for preventing theft of the vehicle and for blocking illegal intrusion from the outside. Further, the control unit 200 has a communication unit 204 that transmits the drive signals from the control unit 200 to the control communication network 6.

The control unit 300 has a calculation device 305 for real-time control that executes calculations. The calculation device 305 calculates control target values for the vehicle on the basis of signals of the sensor 401 and the vehicle traveling route updated in the control unit 200, and outputs drive signals for driving the drive unit on the basis of the control target values. The drive signals include signals for vehicle energy management, power transmission operation, steering operation and braking operation. The drive signals are transferred from a communication unit 304 through the control communication network 6 to the drive unit 31.

<Hardware Configuration of Control Unit>

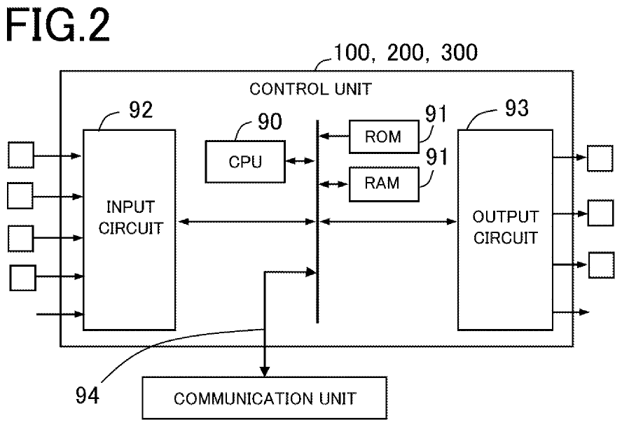

In FIG. 2, a hardware configuration diagram of the control units 100, 200, 300 according to Embodiment 1 is shown. Respective sets of functions of the control units 100, 200, 300 are implemented by processing circuits included in the control units 100, 200, 300. Specifically, as shown in FIG. 2, the control units 100, 200, 300 each include as the processing circuit: an arithmetic processing device 90 (computer) such as a CPU (Central Processing Unit) or the like; storage devices 91 that perform data transactions with the arithmetic processing device 90; an input circuit 92 that inputs external signals to the arithmetic processing device 90; an output circuit 93 that externally outputs signals from the arithmetic processing device 90; an interface 94 for performing data transactions with an external device such as a communication unit; and the like.

As the arithmetic processing device 90, there may be included an ASIC (Application Specific Integrated Circuit), an IC (Integrated Circuit), a DSP (Digital Signal Processor), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner. In the control unit 100, 200, 300, as the arithmetic processing devices 90, the calculation devices 101, 201, 205, 305 are provided. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. The storage devices 91 may be incorporated in the arithmetic processing device 90. The input circuit 92 includes A-D converters or the like to which input signals, sensors and switches are connected, and which serve to input the input signals and signals of the sensors and the switches to the arithmetic processing device 90. The output circuit 93 includes a driver circuit or the like to which electric loads such as gate driving circuits for driving switching elements to be turned ON/OFF are connected, and which outputs control signals to the electric loads from the arithmetic processing device 90. The interface 94 causes data transaction with an external device such as the communication unit, an external storage device, an external control unit or the like.

The functions that the control unit 100, 200, 300 each have, are implemented in such a manner that the arithmetic processing device 90 executes software (programs) stored in the storage device 91 such as a ROM or the like, to thereby cooperate with the other hardware in each of the control units 100, 200, 300, such as the other storage device 91, the input circuit 92, the output circuit 93, etc. Note that the set data of threshold values, determinative values, etc. to be used by each of the control units 100, 200, 300 is stored, as a part of the software (programs), in the storage device 91 such as a ROM or the like. Although the functions that the control units 100, 200, 300 each have, may be established each by a software module, it may be established by a combination of software and hardware.

<Calculation Device>

The calculation devices 101, 201 of the control unit 100 in FIG. 1 each stand for a semiconductor integrated circuit which is configured, for example, with one of a SoC (System on a Chip), an FPGA (Field Programmable Gate Array) and a GPU (Graphic Processor Unit), or a combination of multiple ones thereof, and in which an OS (Operating System) for the purpose of non-real-time control is installed, and here, they may each be referred to as a “microcomputer”.

The calculation devices 205, 305 each stand for a semiconductor integrated circuit fabricated on the assumption that an OS (Operating System) for the purpose of real-time control is installed therein, and here, may each be referred to as a “microcontroller” (or may be simply referred to as a “controller”). These microcontrollers are internally provided with their respective memories for storing programs to be operated in the calculation devices 205, 305, so that external memories for them are eliminated in FIG. 1. However, like the calculation devices 101, 201, the calculation devices 205, 305 may be provided with external memories.

Here, real-time control is control designed to be completed within a specified period. For example, with respect to the cylinder in a vehicle 4-stroke internal combustion engine, when control is made to surely complete calculation of fuel injection amount until the beginning of BDC (Bottom Death Center) in the exhaust process, to thereby make ready for the start of fuel injection, it is real-time control. In contrast, when control is to accumulate the fuel injection amounts and to divide the result by the travel distance to thereby display the average fuel cost, without setting particular time restriction, it is non-real-time control.

Further, when control is made to calculate an entire traveling route up to the destination of an automated driving vehicle and to display that route on a screen, provided that the destination is set initially, it is not subjected to time restriction and thus corresponds to non-real-time control. In contrast, when, in order to take avoidance action by turning operation or braking operation at the approach to a front vehicle, control has to be executed to complete calculation within, for example, 50 ms, it corresponds to real-time control.

<Failure of Calculation Device>

Each of the calculation devices 101, 201, 205, 305 has a failure detection function (self-diagnosis function) and, when it has failed, informs the other non-failed calculation devices of its failed state through the core communication network 2. Other than using self-diagnosis, failure detection may be performed in such a manner that the calculation device and the other calculation device transmit signals for normality verification to each other, to thereby mutually monitor whether they are each normally operated.

The memories 102, 202 each stand for a semiconductor recording device capable of storing large volume programs, for example, a NAND-type flash memory or the like. In the respective memories 102, 202, programs of the calculation device 101, 201 are retained. Furthermore, the memories 102, 202 have roles to store beforehand drive signals to be used for the calculation devices 205, 305 at failures, in a period (transition period) until the functions of them are transferred to the calculation devices 102, 201. The memories 102, 202 may store the drive signals in a period from a current time until the elapse of the predetermined transition period in a shared manner; however, they may each store data of the same contents.

The calculation device 101 has a function of backing up the functions of the calculation device 201 and/or the calculation device 205 when one or both of the calculation device 201 and the calculation device 205 have failed. The calculation device 201 has a function of backing up the functions of the calculation device 101 and/or the calculation device 305 when one or both of the calculation device 101 and the calculation device 305 have failed. The calculation device 205 has a function of backing up the functions of the calculation device 201 and/or the calculation device 305 when one or both of the calculation device 201 and the calculation device 305 have failed. The calculation device 305 has a function of backing up the functions of the calculation device 101 and/or the calculation device 205 when one or both of the calculation device 101 and the calculation device 205 have failed. In the memories 102, 202 and the internal memories of the calculation devices 205, 305, programs designed to run at the time of failure/failures are prestored. After receiving information about which calculation device has failed, the non-failed calculation device in the control units 100, 200, 300 changes the schedule of installed functions in order to also cover the functions of the failed calculation device at the same time. For continuing automated driving, the schedule is so changed that the priority of vehicle control in which control delay is not allowed is increased.

The backup configuration of the calculation devices 101, 201, 205, 305 is not limited to the above, and may be established by other combinations. It suffices that the calculation devices are configured so as to have functions by which, if failures occur in two of the calculation devices, the thus-failed calculation devices are backed up by the other calculation device/devices without occurrence of failure.

<Case where Two Calculation Devices for Real-Time Control have Failed>

When the calculation devices 205, 305 for real-time control have both failed, the calculation devices 101, 201 for non-real-time control take over the functions of the calculation devices 205, 305 for real-time control. On this occasion, the calculation devices 101, 201 for non-real-time control predict a vehicle control state after the elapse of a predetermined prediction period, to thereby transfer respective expected drive signals based on the thus-predicted vehicle control state to the signal correction units 103, 203. The signal correction units 103, 203 are each configured with a circuit or software for determining interpolated drive signals from the expected drive signals outputted by the calculation devices 101, 201, and for performing information interpolation between fluctuated cycles and between expected drive signals. A semiconductor integrated circuit capable of high-speed calculation processing, for example, an FPGA, an ASIC (Application Specific Integrated Circuit) or the like, is used therefor. Instead, the signal correction units 103, 203 may be incorporated as programs, each as one of the respective functions of the calculation devices 101, 201.

With respect to how to interpolate information of actuator drive cycles by the signal correction units 103, 203, the interpolated drive signal may be generated on the basis of a moving average value or a spline curve of a history about each of the expected drive signals received from each of the calculation devices 101, 201 for non-real-time control. Instead, the signal correction units 103, 203 may interpolate drive signals according to control waveforms unique to the actuators. For example, the invalid time of the fuel injector varies depending on the driven time in some cases, and the braking force of the electric brake and the motor drive current have hysteresis in some cases. The signal correction units 103, 203 interpolate drive signals while taking into account such characteristics. The interpolation method may be selected appropriately according to conditions in a vehicle environment at an abnormal time, under which the operations have to be performed.

In order to eliminate a delay that may occur due to calculation for non-real-time control, the calculation devices 101, 201 find out information of a current location, a speed and an acceleration rate of the vehicle, from information of the sensor 401 or the like, to thereby predict the vehicle control state after the elapse of the predetermined prediction period. The calculation devices 101, 201 transfer the expected drive signals based on the thus-predicted vehicle control state to the signal correction unit 103, 203.

The signal correction units 103, 203 each output the interpolated drive signals on the basis of a currently outputting drive signals and the expected drive signals after the elapse of the predetermined prediction period, to the drive unit 31 at predetermined cycles. On this occasion, the signal correction units 103, 203 may execute interpolation while taking a delay due to signal correction processing, into consideration.

From when the failures of the calculation devices 205, 305 for real-time-control are determined, the calculation devices 101, 201 for non-real-time control take over the functions of the calculation devices 205, 305 for real-time control and predict the vehicle control state after the elapse of the predetermined prediction period, and then transfer the expected drive signals based on the thus-predicted vehicle control state, to the signal correction units 103, 203. A transition period is required from the determination of the failures until the transfer of the expected drive signals by the calculation devices 101, 201. The communication units 104, 204 read out from the memories 102, 202, data of drive signals to be transmitted in this transition period to the drive unit 31, and transmit these drive signals thereto. In order to achieve this, during when the calculation device 205 or the calculation device 305 operates normally, its drive signals to be given from a current time until the elapse of the transition period are prestored in the memory 102 or 202 by the calculation device 101 or 201, or the calculation device 205 or 305. When the vehicle is in automated driving and there is no failure in any one of the calculation devices 101, 201, 205, 305, drive signals to be used until measures are taken at an abnormal time, may be written in the memories 102, 202 through the core communication network 2. Further, at the time of executing writing of the drive signals in the memories 102, 202, when they are overwritten in a memory region, it is possible to suppress the used capacity of the memory region, to thereby prevent the other capacity for programs from becoming tight.

The transition period from the determination of the failures of the calculation devices 205, 305 until the drive signals to be transmitted to the drive unit 31 are transmitted thereto after being read out from the memories 102, 202, should be set longer than a period until the calculation devices 101, 201 begin outputting the expected drive signals to the signal correction units 103, 203. It is allowed that, when the expected drive signals are outputted to the signal correction units 103, 203, a sequence for sending a drive-signal switching command signal is added to each of them, to thereby accurately and seamlessly take measures at the failures.

The allocation of the software to be executed by the calculation devices 101, 201 for non-real-time control, that is described so far in Embodiment 1, is just an example, and there is no problem if other software is allocated additionally or with the deletion of the exemplified software, or if the allocation is changed between the calculation devices 101, 201. The allocation of the software to be executed by the calculation devices 205, 305 for real-time control is just an example, and there is no problem if other software is allocated additionally or with the deletion of the exemplified software, or if the allocation is changed between the calculation devices 205, 305.

Further, the configuration described in Embodiment 1 corresponds to the case where each of the numbers of the calculation devices (101, 201) for non-real-time control and the calculation devices (205, 305) for real-time control is two; however, even when three or more calculation devices are provided for each control, the system is applicable to take measures when failures have occurred in these calculation devices.

<Flowchart>

<Processing for Real-Time Control>

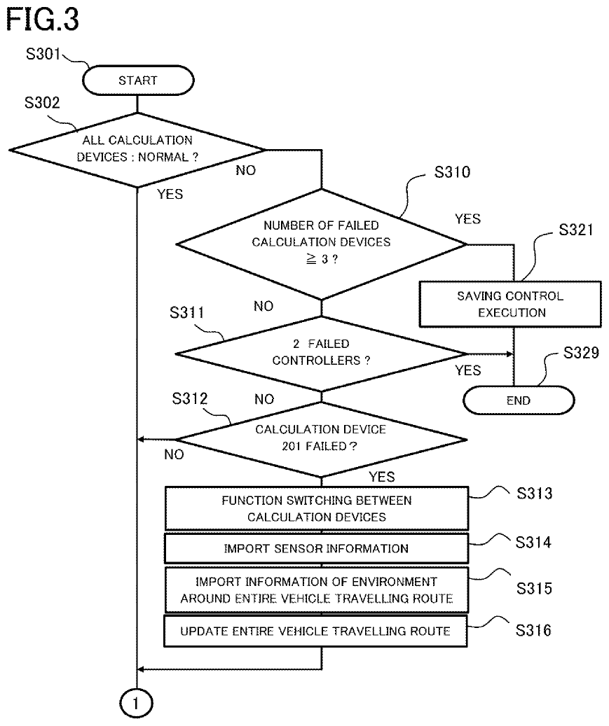

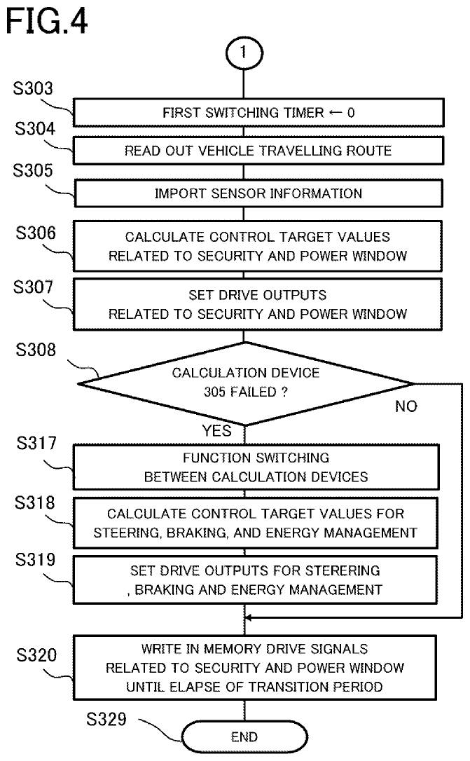

FIGS. 3, 4 are flowcharts of calculation by the calculation device (microcontroller) 205 for real-time control according to Embodiment 1 (hereinafter, may be referred to as a “controller”). FIG. 4 shows processing subsequent to FIG. 3. The processing of FIGS. 3, 4 is executed, for example, every 1 ms. Since this processing is used for real-time control, the control process is completed certainly within 1 ms.

The processing is started from Step S301, and in Step S302, whether or not all of the calculation devices are normal is determined. If all of them are normal (judgement is YES), in Step 303 in FIG. 4, a first switching timer possessed by the communication unit 104 in the control unit 100 is cleared. The first switching timer is a timer that, when the calculation devices for real-time control (controllers) have both failed, determines timing of switching from the drive signals read out from the memory 102 to the drive signals read out from the signal correction unit 103.

In Step S304, the vehicle traveling route calculated by the calculation device 201 is read out. In Step S305, sensor information is imported. In Step S306, control target values related to the security and directed to the power window are calculated. In Step S307, drive outputs related to the security and directed to the power window are set to be transmitted from the communication device.

In Step S308, whether or not the calculation device 305 has failed is confirmed. This is because if processing proceeds to Step S303 from Step S316, a case may arise that the calculation device 305 has failed. If the calculation device 305 has failed (judgement is YES), the functions of the calculation device 305 are instead executed in Step S318 and Step S319. For that purpose, in Step S317, function switching between the calculation devices is executed.

In Step S318, control target values for steering, braking and energy management are calculated. In Step S319, drive outputs for them are set to be transmitted from the communication device.

In Step S320, drive signals related to the security and directed to the power window until the elapse of the transition period, are written in the memory. This process is to get ready for the case where the controllers have both failed. The processing is terminated at Step S329.

If, in Step S302, not all of the calculation devices are normal (judgement is NO), whether or not three or more of the calculation devices have failed is determined in Step S310. If three or more calculation devices have failed (judgement is YES), it is not possible to insure autonomous operations in Embodiment 1. Thus, in Step S321, saving control is executed and then the processing is immediately brought to emergency stop. At the time of the emergency stop, such control may be added that informs the surroundings of danger in such a manner that lighting of vehicle hazard lamps and/or sounding of a vehicle horn is controlled by the remaining calculation device. In order to achieve such control, it is necessary to make the actuator-side wiring lines redundant. Thereafter, the processing is terminated at Step S329.

If, in Step S310, there are not three or more calculation devices having failed (judgement is NO), whether or not the two controllers have failed is determined in Step S311. If the two controllers have failed (judgement is YES), it is meant that the calculation device 205 has also failed, so that the processing is terminated directly at Step S329.

If, in Step S311, the two controllers have not all failed (judgement is NO), whether or not the calculation device 201 has failed is determined in Step S312. If the calculation device 201 has failed (judgement is YES), the functions of the calculation device 201 is instead executed in Step S314 to Step S316. For that purpose, in Step S313, function switching between the calculation devices is executed. After the Step S316, like in the case where, in Step S312, the calculation device 201 has not failed (judgement is NO), the flow moves to Step S303.

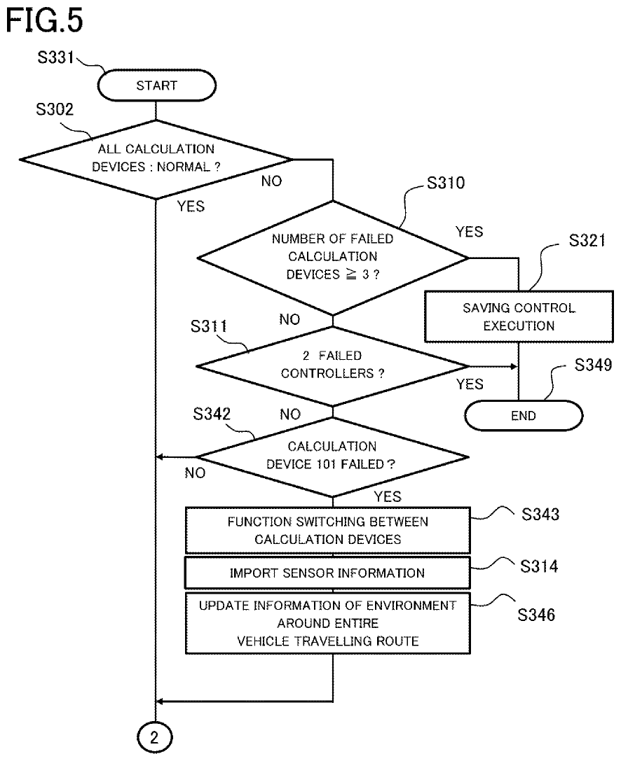

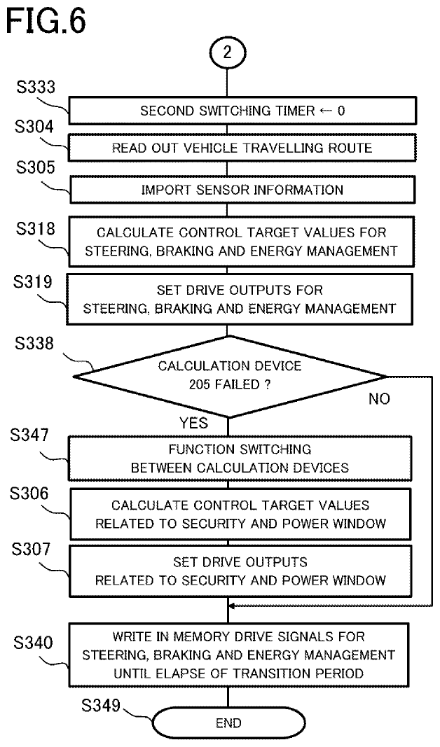

FIGS. 5, 6 are flowcharts of calculation by the calculation device (controller) 305 for real-time control according to Embodiment 1. FIG. 6 shows processing subsequent to FIG. 5. The processing of FIG. 6 is executed, for example, every 1 ms. Since this processing is used for real-time control, the control process is completed certainly within 1 ms.

FIGS. 5, 6 are basically the same as FIGS. 4, so that description will be made only on different portions therebetween. In Step 333 in FIG. 6, a second switching timer possessed by the communication unit 204 in the control unit 200 is cleared. The second switching timer is a timer that, when the calculation devices for real-time control (controllers) have both failed, determines timing of switching from the drive signals read out from the memory 202 to the drive signals read out from the signal correction unit 203.

In Step S338, whether or not the calculation device 205 has failed is confirmed. This is because if processing proceeds to Step S333 from Step S346, a case may arise that the calculation device 205 has failed. If the calculation device 205 has failed (judgement is YES), the functions of the calculation device 205 are instead executed in Step S306 and Step S307. For that purpose, in Step S347, function switching between the calculation devices is executed.

In Step S340, drive signals for steering, braking and energy management until the elapse of the transition period, are written in the memory. This process is to get ready for the case where the controllers have both failed. The processing is terminated at Step S349.

In Step S342, whether or not the calculation device 101 has failed is determined. If the calculation device 101 has failed (judgement is YES), the functions of the calculation device 101 are instead executed in Step S314 and Step S346. For that purpose, in Step S343, function switching between the calculation devices is executed. After the Step S346, like in the case where, in Step S342, the calculation device 101 has not failed (judgement is NO), the flow moves to Step S333.

<Processing for Non-Real-Time Control>

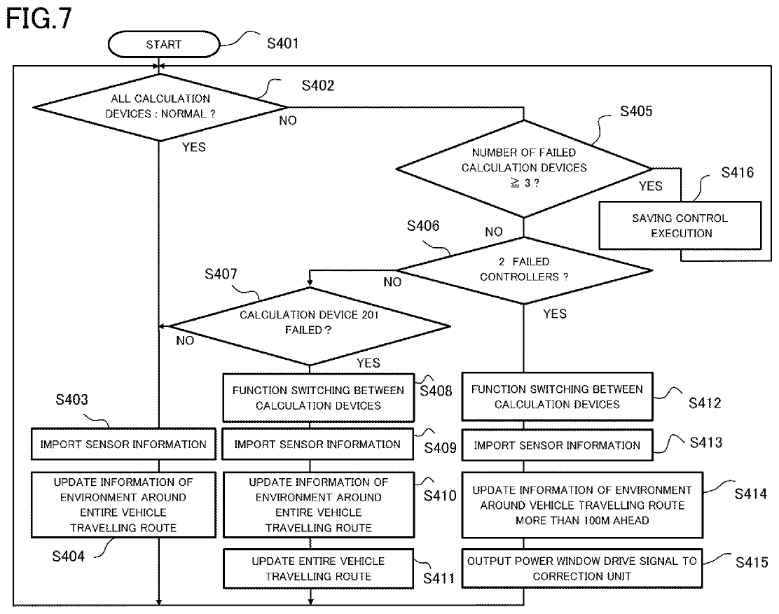

FIG. 7 is a flowchart of calculation for non-real-time control by the calculation device 101 according to Embodiment 1. The calculation device 101 is configured to always execute processing allocated thereto, without setting a control time period.

While the processing is started at Step S401, thereafter, the processing is repeated continuously. For example, let's assume the case of executing calculation for non-real-time control that takes a processing time of up to about 100 ms. In Step S402, whether or not all of the calculation devices are normal is confirmed. If all of the calculation devices are normal (judgement is YES), sensor information is imported in Step S403, and in next Step S404, information of the environment around the entire vehicle traveling route is updated. Thereafter, the flow returns to Step S402 and the processing is repeated.

If, in Step S402, not all of the calculation devices are normal (judgement is NO), the flow moves to Step S405. In Step S405, whether or not three or more of the calculation devices have failed is determined, and if three or more of them have failed (judgment is YES), saving control is executed in Step S416, and thereafter, the flow returns to Step S402.

If, in Step S405, there are not three or more calculation devices having failed (judgement is NO), whether or not the two controllers have failed is determined in Step S406. If the two controllers have not all failed (judgement is NO), whether or not the calculation device 201 has failed is determined in Step S407. If the calculation device 201 has failed (judgement is YES), the calculation device 101 also executes the functions of the calculation device 201 instead thereof. Specifically, the calculation device 101 executes not only its own function of updating information of the environment around the entire vehicle traveling route according to Step S410, but also the function of updating the entire vehicle traveling route according to Step S411. For that purpose, in Step S408, calculation-device function switching is executed and, in Step S409, importation of sensor information is executed. After Step S411, the flow returns to Step S402.

If, in Step S406, the two controllers have failed (judgement is YES), calculation-device function switching is executed in Step S412. In order to take part in backing up the calculation devices (controllers) for real-time control, the calculation device 101 for non-real-time control separately executes preferential processing to be executed with a timer of 10 ms, and its normal processing. Processing from Step S413 to Step S415 shows non-preferential processing. In Step S413, sensor information is imported, and in Step S414, information of an environment around the vehicle traveling route more than 100 m ahead is updated, and then in Step S415, a power window drive signal is outputted to the correction unit. Thereafter, the flow returns to Step S402.

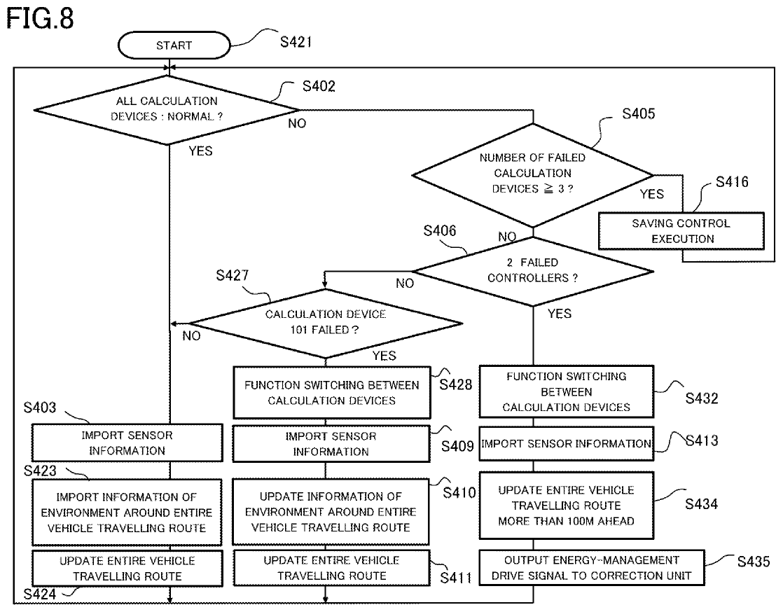

FIG. 8 is a flowchart of calculation for non-real-time control by the calculation device 201 according to Embodiment 1. The calculation device 201 is configured to always execute processing allocated thereto, without setting a control time period. The structure of this flowchart is similar to the flowchart in FIG. 7 related to the calculation device 101, so that description will be made on different portions therebetween.

While the processing is started at Step S421, thereafter, the processing is repeated continuously. For example, let's assume the case of executing calculation for non-real-time control that takes a processing time of up to about 100 ms. In Step S402, whether or not all of the calculation devices are normal is confirmed. If all of the calculation devices are normal (judgement is YES), sensor information is imported in Step S403, and in next Step S423, importation of information of an environment around the entire vehicle traveling route is executed, and then in Step S424, the entire vehicle traveling route is updated. Thereafter, the flow returns to Step S402 and the processing is repeated.

In Step S427, whether or not the calculation device 101 has failed is determined. If the calculation device 101 has failed (judgement is YES), the calculation device 201 also executes the functions of the calculation device 101 instead thereof. Specifically, the calculation device 201 executes not only its own function of updating the entire vehicle traveling route according to Step S411, but also the function of updating information of the environment around the entire vehicle traveling route according to Step S410. For that purpose, in Step S428, calculation-device function switching is executed and, in Step S409, importation of sensor information is executed. After Step S411, the flow returns to Step S402.

In Step S406, if the two controllers have failed (judgement is YES), calculation-device function switching is executed in Step S432. In order to take part in backing up the calculation devices (controllers) for real-time control, the calculation device 201 for non-real-time control separately executes preferential processing to be executed with a timer of 10 ms, and its normal processing. Processing from Step S413 to Step S435 shows non-preferential processing. In Step S413, sensor information is imported, and in Step S434, an entire vehicle traveling route more than 100 m ahead is updated, and then in Step S435, energy-management related drive signals are outputted to the correction unit. Thereafter, the flow returns to Step S402.

<Preferential Processing in Non-Real-Time Processing>

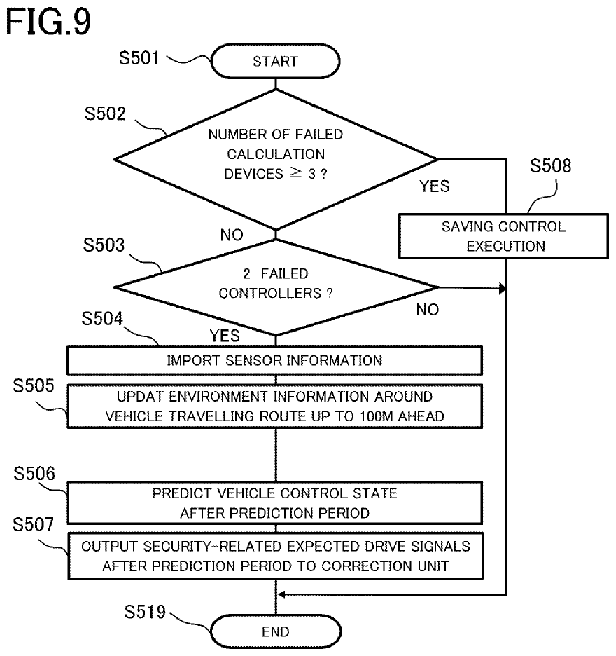

FIG. 9 is a flowchart of preferential processing in calculation for non-real-time control by the calculation device 101 according to Embodiment 1. When the two controllers have failed, the functions related to vehicle security are preferentially executed, and the control cycle therefor is simulatively increased using the signal correction unit so that the control becomes close to real-time control.

The processing of FIG. 9 is executed, for example, every 10 ms. By this calculation device for non-real-time control, the preferential processing is executed in a manner triggered by a timer, and the non-preferential processing is executed as before, as calculation for non-real-time control.

The processing is started from Step S501, and in Step S502, whether or not three or more calculation devices have failed is determined. If three or more calculation devices have failed (judgement is YES), in Step S508, saving control is executed and then the processing is terminated at Step S519. If, in Step S502, there are not three or more calculation devices having failed (judgement is NO), whether or not the two controllers have failed is determined in Step S503. If the two controllers have not all failed (judgement is NO), the preferential processing is not executed and the processing is terminated directly at Step S519.

If, in Step S503, the two controllers have failed (judgement is YES), the preferential processing from Step S504 to Step S507 is executed. In Step S504, sensor information is imported; in Step S505, information of the environment around a vehicle traveling route up to 100 m ahead is updated; in Step S506, a vehicle control state after the prediction period is predicted; and in Step S507, security-related expected drive signals after the prediction period are outputted to the correction unit; and then the processing is terminated at Step S519.

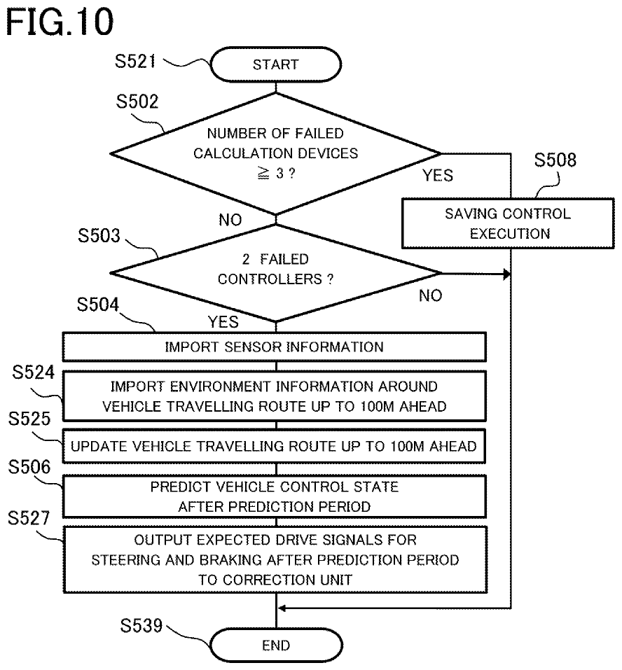

FIG. 10 is a flowchart of preferential processing in calculation for non-real-time control by the calculation device 201 according to Embodiment 1. When the two controllers have failed, the functions related to steering and braking of the vehicle are preferentially executed, and the control cycle therefor is simulatively increased using the signal correction unit so that the control becomes close to real-time control.

The processing of FIG. 10 is executed, for example, every 10 ms. By this calculation device for non-real-time control, the preferential processing is executed in a manner triggered by a timer, and the non-preferential processing is executed as usual, as calculation for non-real-time control. Differences of the flowchart of FIG. 10 from the flowchart of FIG. 9 will be described from Step S503.

In Step S503, whether or not the two controllers have failed is determined. If the two controllers have not all failed (judgement is NO), the preferential processing is not executed and the processing is terminated directly at Step S539.

If, in Step S503, the two controllers have failed (judgement is YES), the preferential processing from Step S504 to Step S527 is executed. In Step S504, sensor information is imported; in Step S524, information of an environment around the vehicle traveling route up to 100 m ahead is imported; in Step S525, the vehicle traveling route up to 100 m ahead is updated; in Step S506, a vehicle control state after the prediction period is predicted; and in Step S527, expected drive signals for steering and braking after the prediction period, are outputted to the correction unit; and then the processing is terminated at Step S539.

<Memory, Signal Correction Unit and Communication Unit>

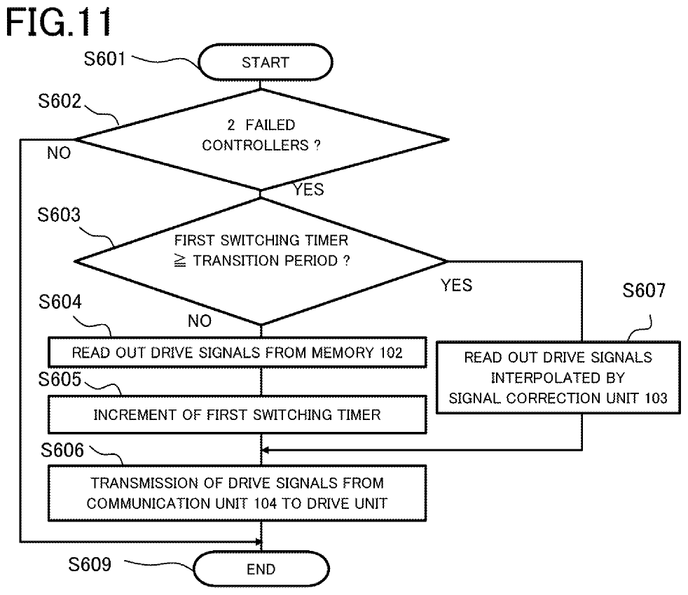

FIG. 11 is a flowchart about drive signals outputted by the communication unit 104 according to Embodiment 1. The processing of FIG. 11 is executed, for example, every 1 ms, by the communication unit. The processing is started from Step S601, and in Step S602, whether or not the two controllers have failed is determined. Since this processing is executed only when the two controllers have failed, when the two controllers have not all failed (judgement is NO), the flow is then terminated at Step S609.

If the two controllers have failed (judgement is YES), in Step S603, whether or not the value of the first switching timer is equal to or more than the predetermined transition period is determined. If the value is not equal to or more than the transition period (judgement is NO), in Step S604, the drive signals are read out from the memory 102. Then, in Step S605, the first switching timer is incremented. In Step S606, the communication unit transmits the drive signals through the control communication network 6 to the drive unit 31. The processing is terminated at Step S609.

If, in Step S603, the value of the first switching timer is equal to or more than the transition period (judgement is YES), the drive signals interpolated by the signal correction unit are read out in Step S607. Then, in Step S606, the communication unit transmits such drive signals through the control communication network 6 to the drive unit 31.

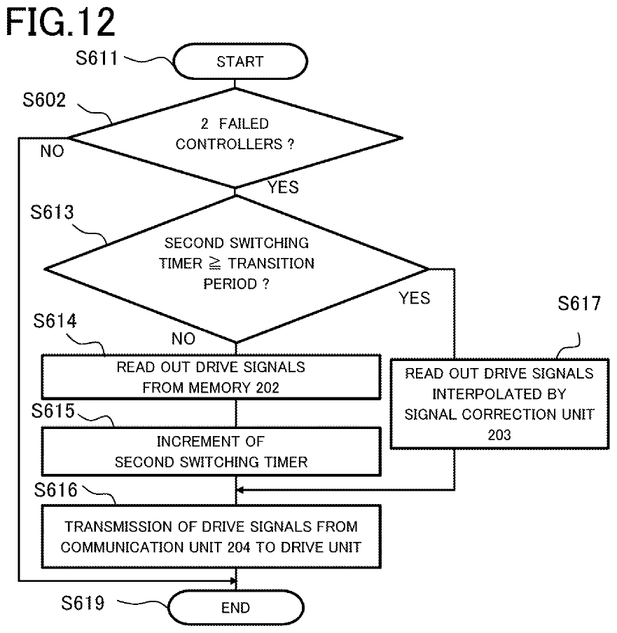

FIG. 12 is a flowchart about drive signals outputted by the communication unit 204 according to Embodiment 1. FIG. 11 shows a flowchart with respect to the communication unit 104, whereas FIG. 12 illustrates that with respect to the communication unit 204. The details of these flowcharts are mutually the same except for the objects, so that the corresponding description is omitted here.

According to the description about FIGS. 11 and 12, the communication units 104, 204 execute drive-signal switching; however, drive-signal switching may be executed by the signal correction units 103, 203. A configuration is also allowable in which the memories 102, 202 or the calculation devices 101, 201, or other external devices, execute that switching.

According to Embodiment 1, if the failed calculation devices are not both the calculation devices 205, 305, at least one of the non-failed calculation devices can make real-time calculations. Thus, substitution functions for the failed calculation device that are written in the memory installed in each corresponding one of the calculation devices, are activated, so that automated driving is continued.

The description has been made by showing an example in which, with respect to the calculation devices 205, 305 for real-time control and the calculation devices 101, 202 for non-real-time control, the information of the environment around the vehicle is updated, the vehicle traveling route is updated, security and the power window is controlled in real-time, and steering, braking and energy management are controlled in real-time. However, how control is executed by each of the calculation devices is not limited by this Embodiment, and the allocation to the calculation devices is also not limited by this Embodiment.

In the above description, such a case has been described where the calculation devices 205, 305 for real-tile control have enough ability to take over the functions of the calculation devices 101, 201 for non-real-time control. However, when the calculation devices 205, 305 for real-time control have no margin for their processing load, the calculation for non-real-time control may be executed little by little in a divided manner. Meanwhile, in the description for FIG. 3 to FIG. 12, the values of “1 ms”, “10 ms”, “100 ms”, “100 m” and the like are just examples, and the applicable values are not limited thereto.

Further, when real-time control is to be executed only by non-real-time calculation, depending on what microcomputer is used, a case may arise that the vehicle speed, etc. are required to be restricted because of the limit of processing capability. Thus, when the failures of the calculation devices 205, 305 are found, it is allowed to add such control to cause the vehicle to travel up to a nearby escape place while decreasing the speed, and to stop there.

As described above, the vehicle control system according to Embodiment 1 makes it possible, for an automated driving vehicle to perform autonomous traveling, to take measures for autonomous traveling even when two calculation devices for real-time control have failed, without needlessly increasing the redundancy.

### 2. Embodiment 2

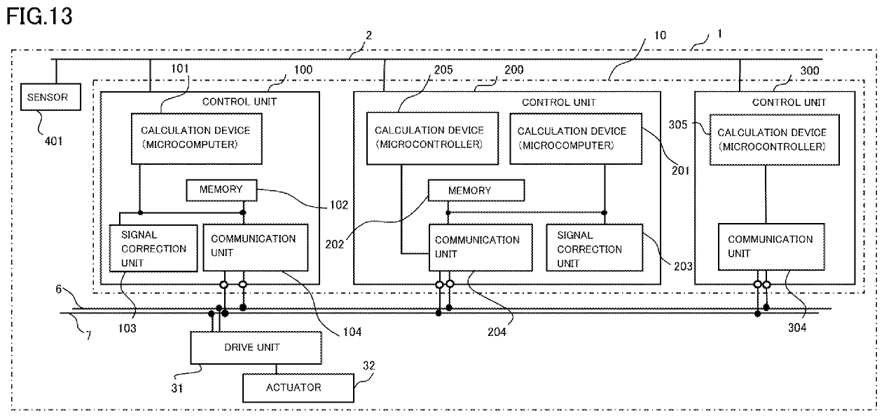

FIG. 13 is a configuration diagram of a vehicle control system according to Embodiment 2. It differs from FIG. 1 according to Embodiment 1, in that the control communication network is duplicated into control communication networks 6, 7. The drive unit 31 is connected through the duplicated communication networks to the calculation devices for real-time control and the calculation devices for non-real-time control, and one of the communication networks is used when all of these calculation devices are normal, and the other communication network is used when any one of these calculation devices has failed. Accordingly, operations of the calculation devices in a normal state and those in an abnormal state are definitely separated from each other, so that the reliability is improved.

It is noted that, in Embodiment 1 and Embodiment 2, in terms of their configurations, there is no mention about the backup of the sensor 401, the control communication network 6, the drive unit 31 or the actuator 32; however, each of them may be duplicated or triplicated. When it is triplicated, it is possible to withstand double failures. Thus, the triplication is of great significance.

In this application, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

### DESCRIPTION OF REFERENCE NUMERALS

1: vehicle control system, 6, 7: control communication network, 10: control device, 31: drive unit, 32: actuator, 100, 200, 300: control unit, 101, 201, 205, 305: calculation device, 102, 202: memory, 103, 203: signal correction unit, 104, 204, 304: communication unit, 401: sensor

1. A vehicle control system, comprising:
sensors that detect an environment around a vehicle;
actuators that control the vehicle;
a driver that drives the actuators; and
a control device that has two calculation devices for real-time control and two calculation devices for non-real-time control, and that calculates control target values for the vehicle on a basis of signals of the sensors to thereby drive the driver on a basis of the control target values;
wherein these calculation devices are configured so that, when one or two of these calculation devices have failed, another one of these calculation devices takes over functions of the failed calculation device or devices.

2. The vehicle control system of claim 1, wherein the calculation device for non-real-time control, when taking over functions of the calculation device for real-time control, preferentially executes functions related to steering, braking and security of the vehicle.

3. The vehicle control system of claim 1, wherein the calculation device for real-time control or the calculation device for non-real-time control generates drive signals to be given to the driver in a period from a current time to a time after an elapse of a predetermined transition period, and stores the drive signals in a memory; and
wherein, when the calculation device for real-time control has failed and the calculation device for non-real-time control is going to take over functions of said calculation device for real-time control, the drive signals stored in the memory are supplied, in the transition period, to the driver at predetermined cycles.

4. The vehicle control system of claim 1, wherein, when the calculation device for real-time control has failed and the calculation device for non-real-time control is going to take over functions of said calculation device for real-time control, the calculation device for non-real-time control predicts a vehicle control state after an elapse of a predetermined prediction period and transfers expected drive signals based on the thus-predicted vehicle control state to a signal corrector; and
wherein the signal corrector outputs interpolated drive signals on a basis of currently outputting drive signals and the expected drive signals after the elapse of the predetermined prediction period, to the driver at predetermined cycles.

5. The vehicle control system of claim 4, wherein the signal corrector generates the interpolated drive signals according to an output characteristic of each of the actuators.

6. The vehicle control system of claim 4, wherein the signal corrector generates the interpolated drive signal on a basis of a moving average value or a spline curve of a history about each of the expected drive signals after the elapse of the predetermined prediction period, received from the calculation device for non-real-time control.

7. The vehicle control system of claim 1, wherein each of the calculation devices for real-time control and the calculation devices for non-real-time control has a failure detection function and, when having detected a failure, informs the other calculation devices that it has failed.

8. The vehicle control system of claim 1, wherein the driver is connected through duplicated communication networks to the calculation devices for real-time control and the calculation devices for non-real-time control; and
wherein one of said communication networks is used when all of these calculation devices are normal, and the other communication network is used when any one of these calculation devices has failed.

9. The vehicle control system of claim 1, wherein the sensors include a camera that detects the environment around the vehicle, and a locator that detects a location of the vehicle.
